(19) United States
(12) Patent Application Publication
(10) Pub. No.: US 2011/0191149 A1
(43) Pub. Date: Aug. 4, 2011

(54) CUSTOMER-SELECTED PAYMENT CLEARINGHOUSE

(75) Inventors: Jason Blackhurst, Charlotte, NC (US); Michael W. Upton, Charlotte, NC (US)

(73) Assignee: BANK OF AMERICA CORPORATION, Charlotte, NC (US)

(21) Appl. No.: 13/013,683

(22) Filed: Jan. 25, 2011

Related U.S. Application Data
(60) Provisional application No. 61/299,666, filed on Jan. 29, 2010.

(51) Int. Cl. G06Q 30/00; G06Q 40/00

(52) U.S. Cl. 705/14.1; 705/40

(57) ABSTRACT

Embodiments of the invention relate to systems, methods, and computer program products that provide for a customer-selected payment clearinghouse that allows financial institution customers to select which account or accounts to assign/re-assign to a particular payment transaction, concurrent with the transaction or for a predetermined period of time after the transaction has occurred. As such, the present invention allows the customer to assess payment account alternatives after the transaction has occurred and to make informed payment account decisions after the transaction has occurred. In addition, the present invention allows the customer to readily distribute payment across more that one payment account. In specific embodiments of the invention, the financial institution may provide optimal payment account recommendations that maximize one or more customer payment concerns.

### CLAIM OF PRIORITY UNDER 35 U.S.C. §119

The present Application for Patent claims priority to Provisional Application No. 61/299,666 entitled “Customer-Directed Payment Clearinghouse” filed Jan. 29, 2009, and assigned to the assignee hereof and hereby expressly incorporated by reference herein.

### FIELD

In general, embodiments of the invention relate to methods, systems, apparatus and computer program products for processing financial transaction payments and, more particularly, processing payments based on concurrent or post-transaction, customer selection of which payment account(s) is to be used to make the payment.

### BACKGROUND

In conventional consumer transactions, for example, point-of-sale transactions at retail locations or electronic transactions that occur online, the customer must choose their payment account at the time of the transaction. In this regard, if the customer chooses to pay via credit card, the associated credit account is subsequently debited, or if the customer chooses to pay via check, the associated checking account is subsequently debited when the check is presented for payment or otherwise processed, or if the customer chooses to pay with a debit card, the associated debit account, typically a checking or savings account, is debited and the like.

By limiting the customer to the payment account chosen at the time of the transaction, no recourse exists after the transaction to change the payment accounts in the event that circumstances or other factors require or otherwise favor the customer in changing the payment account. For example, at the time of the transaction the customer may be unaware of current balances in his or her respective accounts and/or unaware of which payment account(s) provide the best financial option for the customer in terms of payment.

Additionally, at the time of the transaction the customer may have limited payment account options. Other payment account options, such as credit options or the like, that come available close-in-time after the transaction has occurred are not available to the customer as payment account options after the transaction has occurred. In this regard, financial institutions are not in a position to offer a customer credit payment options for a specific purchase after the purchase has occurred, because the customer has already designated the account from which payment will be made at the time of the transaction. For example, if a customer paid for a transaction with a check (i.e., directed payment from the checking account) and subsequently received a credit offer, the customer would not be able to apply the credit offer to the previous check-paid transaction.

Moreover, in addition to limiting the customer to selection of the payment account at the time of transaction, conventional consumer transactions are not readily conducive to allowing the customer to choose more than one payment account (i.e., spreading the payment across more than one account). In general, online transactions otherwise referred to as e-commerce transactions or Internet transactions are configured such that only one payment type is allowed per transaction. While many online retailers only provide for a customer to pay via a credit card account, others that are configured to provide for a customer to choose a designated payment account at the time of the transaction may not allow for the customer to divide the payment up amongst two or more payment accounts. Thus, the customer may be prevented from completing an online transaction in which he or she prefers to provide a specified portion of the payment from one account (e.g., a credit account) and another specified portion from another account (e.g., another credit account, a debit/checking account, etc.). Additionally, while point-of-sale transactions at retail locations may allow for the payment to be distributed across multiple accounts, such a practice is often time consuming because the sales associates has to conduct a separate transaction for each account from which the customer desires payment.

Therefore, a need exists to develop systems, apparatus, computer program products and the like that do not limit the customer to choosing his or her payment account(s) at the time of the transaction. As such, the desired system should provide the customer with payment flexibility by allowing the customer to make a more informed decision as to payment accounts at a point-in-time after occurrence of the transaction. The more informed decision may take into account which payment account(s) for this particular transaction maximize the customer's financial interests, such as rate of return, interest rate, cash availability, limited debt or the like. Additionally, the desired system should readily provide for the customer to direct payment from more than one account.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for a customer-selected payment clearinghouse that allows for financial institution customers to select which account or accounts to assign/re-assign to a particular payment transaction. The account payment directive may occur concurrent with the transaction or within a predetermined time period after the transaction has occurred. As such, the present invention allows the customer to assess payment account alternatives after the transaction has occurred and to make informed payment account decisions after the transaction has occurred. In addition, the present invention allows the customer to readily distribute payment across more than one payment account. In specific embodiments of the invention, the financial institution may provide optimal payment account recommendations that maximize one or more customer areas of importance, such as rate of return, maintaining cash flow or the like, and the customer may act on the recommendations in selecting payment account(s). In other specific embodiments, the financial institution may provide post-transaction payment offers, such as credit offers, to the customer that may be specifically tailored for the customer or for the transaction, and the customer may act on the payment offers and select the payment account associated with the offer as the payment account.

A method for a customer-selected payment account clearinghouse defines first embodiments of the invention. The method includes receiving, at a computing device, notification of a financial transaction associated with a customer. The method further included receiving, at a computing device, a payment account selection from the customer that is configured to direct payment of the financial transaction from one or more selected payment accounts. The payment account selection is received within a payment account selection time period commencing after occurrence of the financial transaction. In addition, the method includes processing, via a computing device processor, payment of the financial transaction in accordance with the payment account selection.

In specific embodiments the method includes processing, via a computing device processor, payment of the financial transaction in accordance with one or more default payment accounts if the payment account selection is not received from the customer within the payment account selection time. In such embodiments, the method may also include receiving, at a computing device, from the customer, one or more default payment account rules that define the one or more default payment accounts, wherein the default payment rules are based on one or more customer-assigned default payment account parameters. The default payment account parameters may include, but are not limited to, one or more of financial transaction amount, financial transaction type, financial transaction time, payment account balances, or payment account limits.

Further specific embodiments of the method include providing, via a computing device, a payment account selection notification to the customer that includes notice of a pending payment account selection based on the financial transaction and the payment account selection time period.

In other specific embodiments the method includes determining, via a computing device processor, the payment selection time after the occurrence of the financial transaction based on attributes associated with the financial transaction and/or based on a current financial status of the customer.

In still further specific embodiments method includes providing, via a computing device, one or more payment account recommendations to the customer during the payment selection time period. In such embodiments, providing the one or more payment account selection recommendations may further include providing, via a computing device, the one or more payment account selection recommendation to the customer, wherein the one or more payment account selection recommendations are determined based on current financial status of the customer and/or based on one or more customer-selected financial interests.

Moreover, in other specific embodiment the method includes providing, via a computing device, one or more payment-related offers to the customer during the payment selection time period. In such embodiments, providing the one or more payment-related offers may further include providing, via the computing device, the one or more payment-related offers, wherein the payment-related offers are determined based on attributes associated with the financial transaction and/or based on current financial status of the customer.

An apparatus configured for customer-selected payment clearinghouse processing provides for second embodiments of the invention. The apparatus includes a computing platform including at least one processor and a memory. The apparatus further includes a customer-selected payment clearinghouse application stored in the memory and executable by the at least one processor. The application includes a payment selection routine that is configured to receive, from a customer, within a payment account selection time period, a payment account selection associated with a previously occurred financial transaction and configured to direct payment of the financial transaction from one or more selected payment accounts.

In specific embodiments of the apparatus the payment selection routine is further configured to direct payment of the financial transaction from one or more default payment accounts if the payment account selection is not received from the customer within the payment account selection time. In such embodiments, the customer-selected payment clearinghouse application may further include a default payment selection routine configured to receive, from the customer, one or more default payment account rules that define the one or more default payment accounts. The default payment rules are based on one or more customer-assigned default payment account parameters. The payment account parameters may include, but are not limited to, one or more of financial transaction amount, financial transaction type, financial transaction time, payment account balances, or payment account limits.

In other specific embodiments of the apparatus, the customer-selected payment clearinghouse application further comprises a payment account selection notification routine configured to provide a payment account selection notification to the customer that includes notice of a pending payment account selection based on the financial transaction and the payment account selection time period.

In still further specific embodiments of the apparatus, the customer-selected payment clearinghouse application further includes a payment selection time determining routine configured to determine the payment selection time period after the occurrence of the financial transaction based on attributes associated with the financial transaction and/or based on a current financial status of the customer.

In additional specific embodiments of the apparatus, the customer-selected payment clearinghouse application further includes a payment account recommendation routine configured to provide one or more payment account recommendations to the customer during the payment selection time period. In such embodiments, the payment account recommendation routine may be further configured to determine the one or more payment account recommendations based on current financial status of the customer and/or based on one or more customer-selected financial interests.

In still further specific embodiments of the apparatus, the customer-selected payment clearinghouse application further comprises a payment-related offer routine configured to provide one or more payment-related offers to the customer during the payment selection time period. In such embodiments, the payment-related offer routine may be further configured to determine the one or more payment-related offers based on attributes associated with the financial transaction and/or based on current financial status of the customer.

A computer program product that includes a non-transitory computer-readable medium defines third embodiments of the invention. The computer-readable medium includes a first set of codes for causing a computer to receive notification of a financial transaction associated with a customer. In addition, the computer-readable medium includes a second set of codes for causing a computer to receive, from the customer within a payment account selection time period commencing after occurrence of the financial transaction, a payment account selection configured to direct payment of the financial transaction from one or more selected payment accounts. Additionally, the computer-readable medium includes a third set of codes for causing a computer to process payment of the financial transaction in accordance with the payment account selection.

Thus, systems, apparatus, methods, and computer program products herein described provide a customer-selected payment clearinghouse that allows for financial institution customers to select which account or accounts to assign/re-assign to a particular payment transaction. The account payment directive may occur concurrent with the transaction or within a predetermined time period after the transaction has occurred. As such, the present invention allows the customer to assess payment account alternatives after the transaction has occurred and to make informed payment account decisions after the transaction has occurred.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of an apparatus configured to provide a customer-selected payment clearinghouse, in accordance with embodiments of the present invention;

FIG. 2 is a block diagram providing further details and optional aspects of an apparatus configured to provide a customer-selected payment clearinghouse, in accordance with embodiments of the present invention;

FIG. 3 is a block diagram of various apparatus that may be configured to provide a customer-selected payment clearinghouse, in accordance with another embodiment of the invention; and

FIG. 4 is a flow diagram of a method for post-transaction, customer-selected payment account selection, in accordance with embodiments of the present invention.

### DETAILED DESCRIPTION OF EMBODIMENTS OF THE INVENTION

Embodiments of the present invention may now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, infrared, or semiconductor system, apparatus, device, or propagation medium. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages. In addition, the computer program code for executing operations of the present invention can be implemented in any other data processing environment, for example a spreadsheet application or the like.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, present embodiments herein disclosed provide for a customer-selected payment clearinghouse that allows for financial institution customers to select which account or accounts to assign to a particular financial transaction during a payment account selection time period that commences after the occurrence of the financial transaction. As such, embodiments of the present invention allow the customer to assess payment account alternatives after the transaction has occurred and to make informed payment account decisions after the transaction has occurred. In addition, according to further embodiments, the invention allows the customer to readily distribute payment across more that one payment account regardless of the payment input channel. In specific embodiments of the invention, the financial institution may provide optimal payment account recommendations that maximize one or more customer financial concerns, such as maintaining a budget, rate of return, maintaining cash flow or the like, and the customer may act on the recommendations in selecting a payment account. In other specific embodiments, the financial institution may provide post-transaction credit or other payment-related financial offers to the customer, which may be specifically tailored for the customer or for the transaction, and the customer may act on the offers and select the financial offer provided as the payment account.

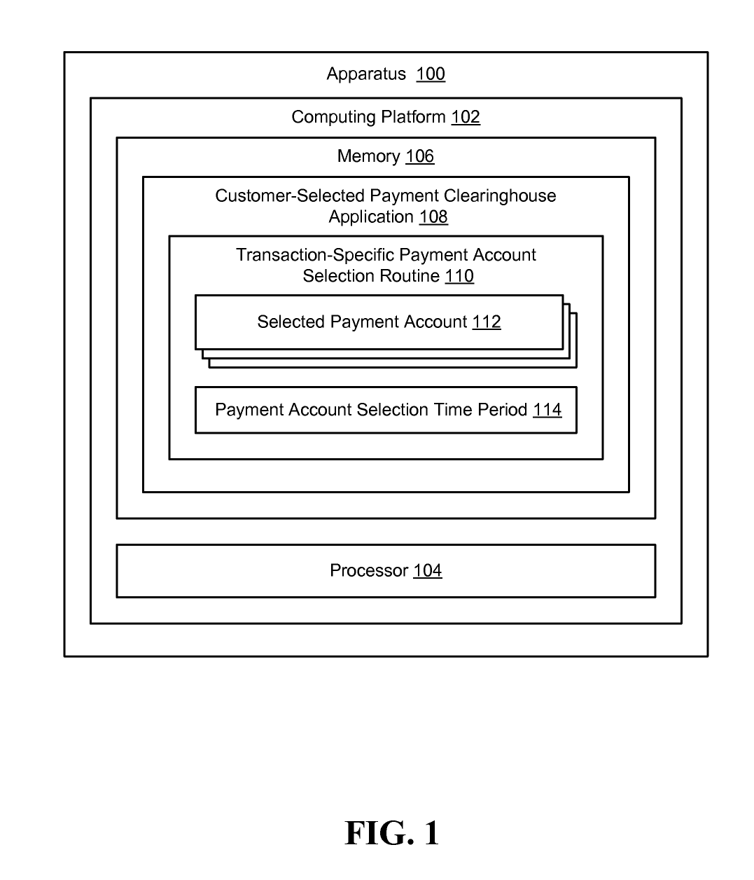

Referring to FIG. 1 a block diagram is depicted of an apparatus 100 configured for providing a customer-selected payment clearinghouse, in accordance with embodiments of the present invention. The apparatus includes a computing platform 102 having at least one processor 104 and a memory 106. The memory 120 stores a customer-selected payment clearinghouse application 108 that is configured to provide a financial institution customer the ability to select from which account or account to direct payment after a transaction occurs. Customer-selected payment clearinghouse application

Customer-selected payment clearinghouse application 108 includes a transaction-specific payment account selection routine 110 that is configured to receive a payment account selection from a customer for a recently occurred transaction and process payment of the transaction from one or more selected payment accounts 112. The payment account selection is received within a payment account selection time period 114 commencing after occurrence of the financial transaction.

Selected payment accounts 112 may include, but are not limited to; credit accounts, such as credit card accounts, lines of credit accounts or the like; checking accounts, savings accounts, such as money market accounts or the like.

In specific embodiments of the invention, the transaction-specific payment account selection routine 110 may be configured to allow the customer to select more than one directed payment account 112. Selecting more than one account may further provide for proportioning payment amongst the multiple payment accounts.

In one embodiment of the invention, the selected payment accounts 112 are limited to the accounts which the customer has at the financial institution that is providing the customer-selected payment clearinghouse, while in other embodiments the directed payment accounts 112 may include other accounts that the customer holds at other financial institutions.

In other specific embodiments of the invention, the payment account selection time 114 may be a predetermined payment account selection time, such as, for example, one day, two days or the like, predetermined by the financial institution providing the customer-selected payment clearinghouse. The predetermined payment account selection time may be consistent across all transactions or it may vary from merchant-to-merchant based on relationships between the financial institution and the merchant. In other embodiment the payment account selection time may be dynamically determined after the occurrence of the transaction based on financial transaction attributes and/or the current financial status of the customer. In the event that the customer does not provide a payment account selection within the payment account selection time period, payment account default rules will apply. Further discussion on payment account default rules are provided infra.

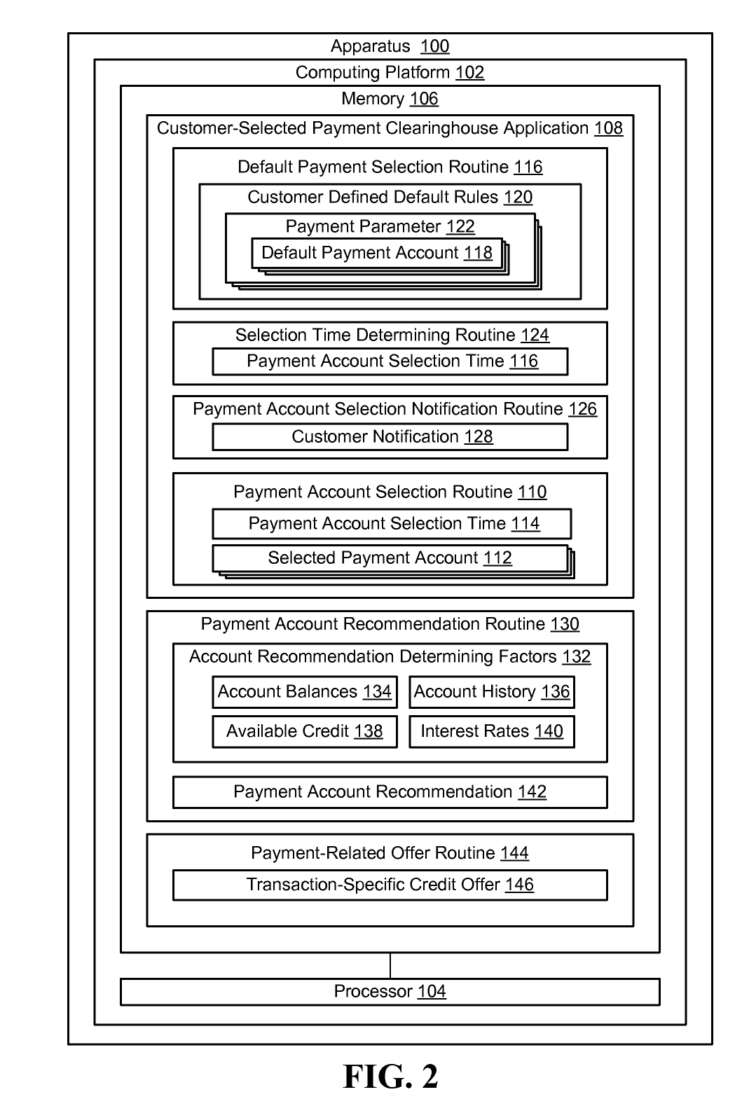

FIG. 2 provides a more detailed depiction of an apparatus 100 configured to provide a customer-selected payment clearinghouse, according to further embodiments of the present invention. In addition to providing greater detail, FIG. 2 highlights various optional components/embodiments not shown in FIG. 1. The apparatus 100 may include any type and/or combination of one or more computing devices, such as servers, personal computers, handheld devices or the like. The apparatus 100 includes computing platform 102 that is operable to receive and execute modules, routines and applications, such as customer-selected payment clearinghouse application 108 or the like. Computing platform 102 includes memory 106, which may comprise volatile and nonvolatile memory such as read-only and/or random-access memory (RAM and ROM), EPROM, EEPROM, flash cards, or any memory common to computing platforms. Further, memory 106 may include one or more flash memory cells, or may be any secondary or tertiary storage device, such as magnetic media, optical media, tape, or soft or hard disk.

Further, computing platform 102 also includes processor 104, which may be an application-specific integrated circuit (“ASIC”), or other chipset, processor, routine circuit, or other data processing device. Processor 104 or other processor such as ASIC may execute an application programming interface (“API”) layer that interfaces with any resident programs, such as impacted customer-selected payment clearinghouse application 108 or the like, stored in the memory 106 of apparatus 100.

Processor 104 includes various processing subsystems embodied in hardware, firmware, software, and combinations thereof, that enable the functionality of apparatus 100 and the operability of the apparatus on a network. For example, processing subsystems allow for initiating and maintaining communications, and exchanging data, with other networked devices. It should be noted that any of the tools, modules, sub-modules, and routines shown and described as being in memory 104 may alternatively be embodied in processing subsystems.

The memory 120 of apparatus 100 includes the aforementioned customer-selected payment clearinghouse application 108 configured to provide a financial institution customer the ability to select from which account or account to direct payment after a financial transaction occurs. It should be noted that the application 108 may be configured to apply to most, and in some instances all, of the financial transactions conducted by a customer or the application 108 may be configured to apply to financial transactions conducted by a customer with participating retailers/vendors (i.e., retailers/vendors having a predetermined relationship with the financial institution). In those embodiments in which the application 108 applies to most, if not all, of the financial transactions conducted by the customer, the financial institution may provide payment to the retailer at the time of transaction but does not debit a customer's account until the customer makes a payment account selection or the payment account selection time lapses and the default payment account applies. Further, in those embodiments in which the application 108 applies to financial transactions conducted with participating retailers, vendors, the financial institution may provide payment to the retailer once the customer selects the directed payment account(s) or the payment account selection time lapses and the default payment account applies.

In specific embodiments of the invention, the customer-selected payment clearinghouse application 108 includes default payment selection routine 116 that is configured to receive a customer selection of one or more default payment accounts 118 that serve as the default account for payment in the event that the customer does not select payment account(s) within the allotted payment account selection time periods. Default payment accounts 118 may include, but are not limited to; credit accounts, such as credit card accounts, lines of credit accounts or the like; checking accounts, savings accounts, such as money market accounts or the like. The customer may select the default account(s) upon opening accounts with the financial institution and the user may change default account designations periodically at the customer's discretion.

In specific embodiments of the invention, the default payment selection routine 116 may be configured to allow the customer to select more than one default payment account 118. Selecting more than one account may further provide for proportioning payment amongst the multiple selected default accounts or prioritizing the order from which the selected accounts should be used for default payment.

In one embodiment of the invention, the default payment accounts 118 are limited to the accounts which the customer has at the financial institution that is providing the customer-selected payment clearinghouse, while in other embodiments the default payment accounts 118 may include other accounts that the customer holds at other financial institutions and that can be administered through the customer-selected payment clearinghouse application 108.

Additionally, the customer-selected payment configuration clearinghouse application 110 may be configured such that if the customer fails to implement the default payment selection routine 110 to select one or more default payment accounts 118, a financial institution-selected default payment account may be implemented as the customer's default payment account.

In specific embodiments of the invention, the default payment selection routine 116 is configured to receive one or more customer-defined default payment account rules 120, which define how and when the default account is to be applied to the payment. The default rules 120 apply to one or more payment parameters 122. Payment parameters may include, but are not limited to payment amount, item/service being purchased, time of payment, account balances, outstanding credit limit or the like. In this regard, the customer may define default rules based on one or more payment parameters. For example, a default rule 120 may be defined that provides for one or more selected default payment accounts 118 to be debited if the payment amount is within a prescribed payment amount range, or if the payment amount is above/below a predetermined payment amount threshold. Thus, in one specific embodiment, a minimum payment threshold may be defined such that all payments below or at the threshold automatically provide for one or more selected default payment accounts 118 to be debited without providing the customer the option to select a directed payment account 118.

In another example, a default rule 120 may be defined that provides for one or more selected default payment accounts 118 to be debited if the payment is for certain product/service within a first predefined group of products/services and/or for one or more other selected default payment accounts 118 to be debited if the payment is for certain product/service within a second predefined group of products/services. In yet another example, a default rule 120 may be defined that provides for one or more selected first default payment accounts 118 to be debited if the payment occurs at a specified time of the year/month/week/day or the like and for one or more second default payment accounts 118 to be debited if the payment occurs outside of the specified time of the year/month/week/day. Such a default rule 112 takes into account that customer accounts may having fluctuating balances depending on the time of year/month/week/day or the like.

In specific embodiments of the invention, the customer-selected payment clearinghouse 108 is configured to apply a predetermined payment account selection time 116, such as one day, two days or the like to all financial institution customers utilizing the customer-selected payment clearinghouse regardless of parameters associated with the financial transaction, such as the amount of the transaction, time of the transaction or the like. In other specific embodiments of the invention, the customer-selected payment clearinghouse 108 may additionally include selection time determining routine 124 that is configured to determine the amount of time that the customer is allowed to make the payment account selection. The determination may be based on the parameters associated with the financial transaction, such as amount of the transaction, time of the transaction, the retailer/vendor associated with the transaction or the like. For example, larger amount transactions may be afforded a shorter payment account selection time 116 or the like. Thus, in such embodiments, the payment account selection time may be a dynamic time that changes from transaction-to-transaction based on parameters associated with the transaction. In addition, the selection time determination may be based on customer attributes, such as preferred customer status, transaction history or the like. For example, customers with a gold level or preferred status may be provided a longer payment account selection time than those customers not having the gold level or preferred status.

Additionally, the customer-selected payment clearinghouse 108 may include payment account selection notification routine 126 that is configured to generate and initiate communication of customer notifications 128 that notify the customer once a financial transaction has occurred that qualifies for payment account selection and the associated payment account selection time 114. The payment account selection time 114 is especially noteworthy of being communicated to the customer in those embodiments in which the time may dynamically fluctuate from transaction-to-transaction based on transaction parameters, customer financial status, merchant relationship or the like. The customer notifications 128 may take the form of any electronic communication message, such as emails messages, text messages, instant messages, voice mail or the like. The form of the customer notifications 128 may be selected by the customer or designated by the financial institution providing the payment clearinghouse. The payment account selection notification routine 126 may be configured to generate and initiate communication of the messages based on predefined financial institution guidelines or the routine 126 may be configured such that the customer may define the timing and/or the form of the messages. In this regard, the customer may configure the routine 126 to send more frequent reminder notifications/messages proximate the expiration of the payment account selection time 114.

As previously discussed in relation to FIG. 1, customer-selected payment clearinghouse 108 additionally includes a transaction-specific payment account selection routine 110 that is configured to receive a customer payment selection of one or more payment accounts 112 for a specific financial transaction, within a predetermined payment account selection time period 114. If the predetermined payment account selection time 114 expires without the customer selecting one or more of the payment accounts 112, the default payment account or accounts 118 are used to satisfy payment of the transaction.

Additionally, the memory 106 of apparatus 100 may include a payment account recommendation determining routine 130 that is configured to allow the financial institution to determine one or more optimal payment account recommendations 142 for the customer. Since the present invention provides the customer with a time window for deciding which payment account to use for a transaction, the present invention also provides ample time for the financial institution to determine one or more optimal payment account recommendations 142 and communicate the recommendations to the customer prior to the customer making the payment account decision. In addition to transaction related characteristics, such as the amount of the transaction, the service/goods associated with the transaction or the like, the payment account recommendation determining routine 130 takes into account one or more account recommendation determining factors 132 in determining the payment account recommendations 142. The account recommendation determining factors may include, but are not limited to, current account balances 134, account balance and transaction history 136, available credit 138, interest rates 140 and the like. Additionally, the payment account recommendation determining routine 130 may be configured to determine more than one payment account recommendation 142. Multiple payment account recommendations 142 take into account that the customer may have a controlling financial interest, such as a need to save for the long-term, a need to minimize debt, a need for current cash availability or the like. In specific embodiments of the invention, the customer may designate one or more controlling financial interests and based on the predetermined controlling financial interests, the payment account recommendation determining routine 130 will determine payment account recommendation(s) based on the customer's pre-defined controlling financial interest(s).

Once the payment account recommendation determining routine 130 has determined the one or more payment account recommendations 142, the recommendations are communicated to the customer. In specific embodiments of the invention, the customer-selected payment clearinghouse application 108 is configured to allow the customer to opt-in or opt-out of payment account recommendations and is further configured to allow the customer to choose a preferred communication form for the recommendations, such as e-mail, text message, instant message, voice message or the like. In other specific embodiments of the invention the payment account recommendations may be communicated in the customer notification 128 that notifies the customer of the need to select payment account(s) for a transaction and the time frame for making the selection.

Additionally, apparatus 100 may include payment-related offer routine 144 that is configured to determine one or more payment-related offers, such as credit offers or the like for the transaction. Similar to the payment account recommendation process, since the present invention provides the customer with a time window for deciding which payment account to use for a transaction, the present invention also provides ample time for the financial institution to determine payment-related offers and communicate the payment-related offers to the customer prior to the customer making the payment account decision. The routine takes into account transaction attributes, such as transaction amount, product/service associated with the transaction and the like and customer financial status related factors, such as customer credit scores, available credit, current debt, credit payment history, current interest rates and the like in determining what transaction-specific payment offers 146, such as credit offers can be provided to the customer.

Once the payment-related offer routine 144 has determined the one or more payment offers 146, the offers are communicated to the customer. In specific embodiments of the invention, the customer-selected payment clearinghouse application 108 is configured to allow the customer to opt-in or opt-out of payment offers and is further configured to allow the customer to choose a preferred communication form for the recommendations, such as e-mail, text message, instant message, voice message or the like. In other specific embodiments of the invention the payment offers may be communicated in the customer notification 128 that notifies the customer of the need to select payment account(s) for a transaction and the time frame for making the selection.

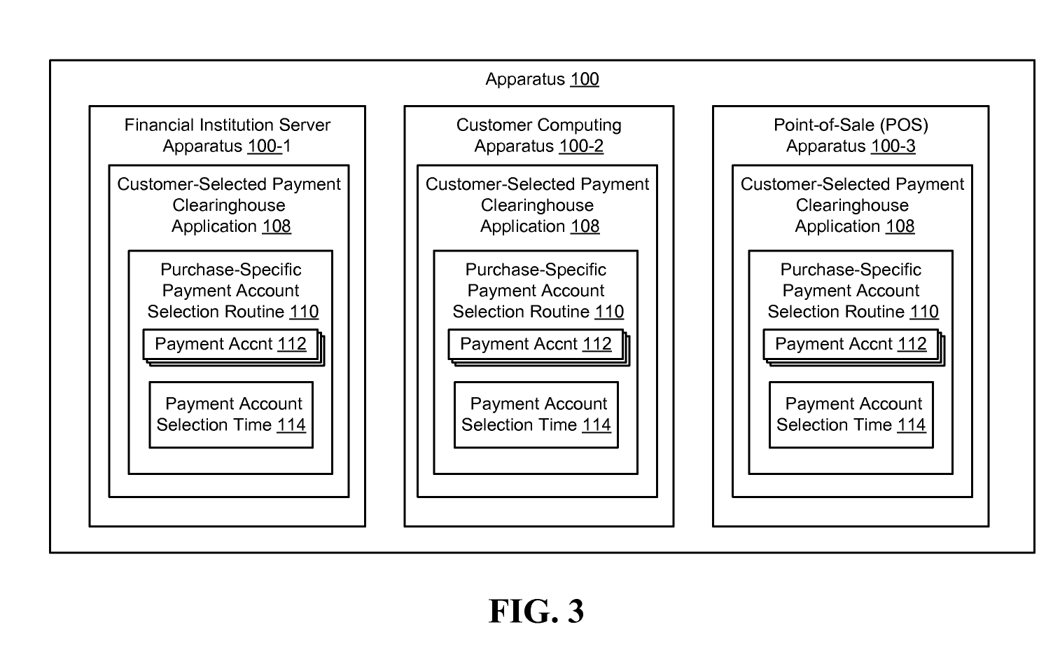

Referring to FIG. 3 a block diagram is shown that illustrates various embodiments of the apparatus 100 that are configured is provide the customer-selected payment clearinghouse, in accordance with embodiments of the present invention. In one embodiment of the invention, the apparatus 100 comprises a financial institution server apparatus 100-1, such that the customer-selected payment clearinghouse application 108 resides on the financial institution server 100-1 and the customers access the application 108 through a network connection, such as the Intranet or the like. In one specific embodiment, the customer-selected payment clearinghouse application 108 may be accessible through a financial institution online banking portal or the like.

In another embodiment of the invention, the apparatus 100 comprises a customer computing device 100-2, such as a personal computer (PC), laptop computer or handheld computing device, such as a smart phone, personal digital assistant (PDA) or the like. In another embodiment of the invention, the apparatus 100 comprises a point-of-sale (POS) device apparatus, such as a touch screen POS payment device or the like. In the instance in which the customer-selected payment clearinghouse application 108 resides on a handheld device or a POS device or in the instance in which the handheld device has wireless network capabilities and the application 108 resides on a financial institution server 100-1 and the transaction occurs at a retail location with the customer in possession of the handheld device, the customer may make the payment account selections at the time of transaction or in close time proximity to the transaction. In specific embodiments, the customer-selected payment clearinghouse application 108 may reside on multiple apparatus to provide the customer with multiple means for selecting payment accounts.

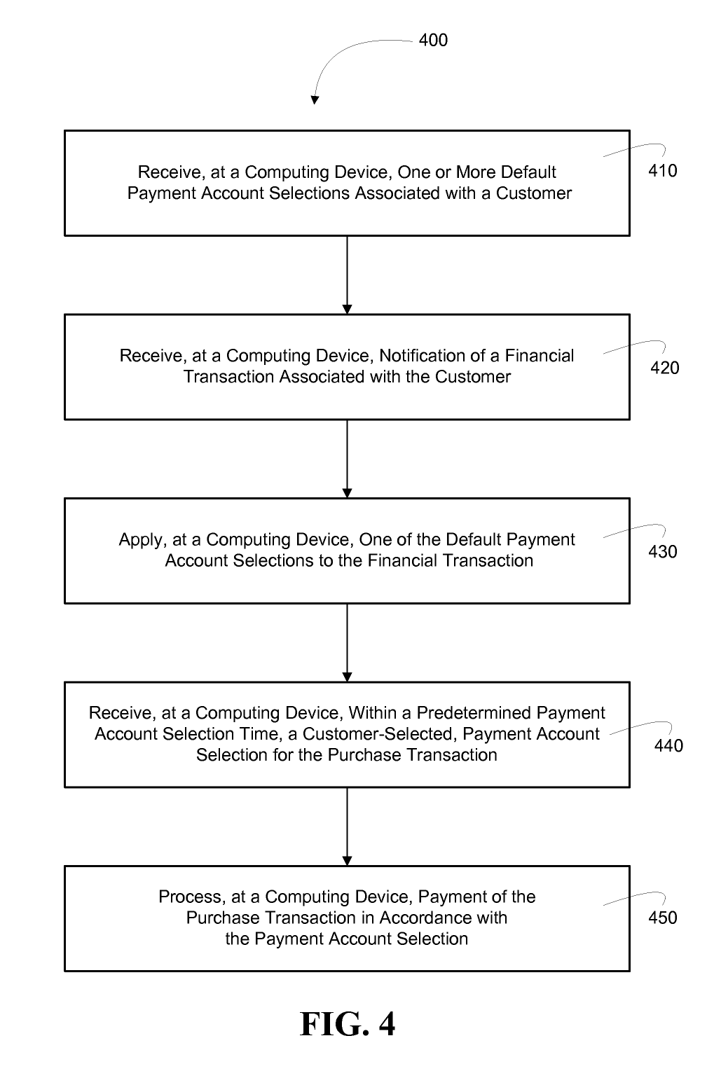

FIG. 4 provides a flow diagram of a method 400 for customer-selected payment clearinghouse processing, in accordance with embodiments of the present invention. At Event 410, one or more default payment account options associated with a customer are received at a computing device. The default payment options may be customer-selected payment options or the default payment option may be provided by the financial institution. In specific embodiments, multiple payment accounts may serve as the default payment account in instances in which the customer desires to distribute payment across more than one account or in instances in which the multiple payment accounts are prioritized to serve as secondary, tertiary default payment accounts in the event that the primary default payment account can not satisfy payment of a transaction. In addition, according to specific embodiments, the customer may define default rules such that the default payment option automatically applies in certain transaction instances without the need to provide the customer with an account selection option, what default accounts should be applied based on transaction characteristics, such as transaction amount, time/date of transaction and the like or customer characteristics such as current account balances or the like.

At Event 420, notification of a financial transaction associated with the customer is received by the financial institution providing the payment clearinghouse. The financial transaction may occur at a retail location, electronically, via the Internet or the like, or at any other transaction receiving location.

At Event 430, once the financial transaction is received, at least one of the default payment account options is applied to the financial transaction. As previously noted the customer may configure the default payment options such that more than one payment account is applied to the financial transaction. Additionally, specific default payment account rules may apply to the default payment account options depending on financial transaction characteristics and or customer-related characteristics.

At Event 440, a customer payment account selection for the financial transaction is received within a predetermined payment account selection time. The customer payment account selection includes one or more directed payment accounts and serves to override the application of the default payment options for the financial transaction. In specific embodiments of the invention, the customer may direct for payment to be distributed from amongst multiple accounts, in which case the customer may additionally provide distribution proportion amounts. In specific embodiments of the invention, the customer may receive payment account recommendations from the financial institution prior to making the payment account selections. The payment account recommendations may serve to provide optimal payment accounts to maximize a customer financial interest, such as maximizing long-term savings, minimizing current debt, or the like. In other specific embodiments, the customer may receive payment offers, such as credit offers, from the financial institution prior to making the payment account selections and the customer may choose to accept the offers and select payment accounts associated with the offers as one or more of the directed payment accounts. At Event 450, processing occurs that debits the one or more customer-selected payment accounts.

Thus, systems, apparatus, methods, and computer program products herein described provide a customer-selected payment clearinghouse that allows for financial institution customers to select which account or accounts to assign/re-assign to a particular payment transaction. The account payment directive may occur concurrent with the transaction or within a predetermined time period after the transaction has occurred. As such, the present invention allows the customer to assess payment account alternatives after the transaction has occurred and to make informed payment account decisions after the transaction has occurred. In addition, the present invention allows the customer to readily distribute payment across more that one payment account. In specific embodiments of the invention, the financial institution may provide optimal payment account recommendations that maximize one or more customer areas of importance, such as rate of return, maintaining cash flow or the like, and the customer may act on the recommendations in selecting payment account(s). In other specific embodiments, the financial institution may provide post-transaction payment offers, such as credit offers, to the customer that may be specifically tailored for the customer or for the transaction, and the customer may act on the payment offers and select the payment account associated with the offer as the payment account.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for a customer-selected payment account clearinghouse, the method comprising:
receiving, at a computing device, notification of a financial transaction associated with a customer;
receiving, at a computing device, a payment account selection from the customer that is configured to direct payment of the financial transaction from one or more selected payment accounts, wherein the payment account selection is received within a payment account selection time period commencing after occurrence of the financial transaction; and
processing, via a computing device processor, payment of the financial transaction in accordance with the payment account selection.

2. The method of claim 1, further comprising processing, via a computing device processor, payment of the financial transaction in accordance with one or more default payment accounts if the payment account selection is not received from the customer within the payment account selection time.

3. The method of claim 2, further comprising receiving, at a computing device, from the customer, one or more default payment account rules that define the one or more default payment accounts, wherein the default payment rules are based on one or more customer-assigned default payment account parameters.

4. The method of claim 3, wherein receiving the one or more default payment account rules further comprises receiving, at the computing device, from the customer, the one or more default payment rules, wherein the default payment rules are based on one or more customer-assigned default payment account parameters, wherein the default payment account parameters include one or more of financial transaction amount, financial transaction type, financial transaction time, payment account balances, or payment account limits.

5. The method of claim 1, further comprising providing, via a computing device, a payment account selection notification to the customer that includes notice of a pending payment account selection based on the financial transaction and the payment account selection time period.

6. The method of claim 1, further comprising determining, via a computing device processor, the payment selection time after the occurrence of the financial transaction based on attributes associated with the financial transaction.

7. The method of claim 1, further comprising determining, via a computing device processor, the payment selection time after occurrence of the financial transaction based on a current financial status of the customer.

8. The method of claim 1, wherein receiving the payment account selection further comprises receiving, at the computing device, the payment account selection, wherein the payment account selection is received within a predetermined payment account selection time period commencing after occurrence of the financial transaction.

9. The method of claim 1, further comprising providing, via a computing device, one or more payment account recommendations to the customer during the payment selection time period.

10. The method of claim 9, wherein providing the one or more payment account selection recommendations further comprises providing, via a computing device, the one or more payment account selection recommendation to the customer, wherein the one or more payment account selection recommendations are determined based on current financial status of the customer.

11. The method of claim 9, wherein providing the one or more payment account selection recommendations further comprises providing, via a computing device, the one or more payment account selection recommendation to the customer, wherein the one or more payment account selection recommendations are determined based on one or more customer-selected financial interests.

12. The method of claim 1, further comprising providing, via a computing device, one or more payment-related offers to the customer during the payment selection time period.

13. The method of claim 12, wherein providing the one or more payment-related offers further comprises providing, via the computing device, the one or more payment-related offers, wherein the payment-related offers are determined based on attributes associated with the financial transaction.

14. The method of claim 12, wherein providing the one or more payment-related offers further comprises providing, via the computing device, the one or more payment-related offers, wherein the payment-related offers are determined based on current financial status of the customer.

15. The method of claim 1, wherein receiving the payment account selection further comprises receiving, at a computing device, the payment account selection that is configured to direct payment of the financial transaction from one or more selected payment accounts, wherein the selected payment accounts are payment accounts held at a financial institution implementing the customer-selected payment account selection method.

16. The method of claim 1, wherein receiving the payment account selection further comprises receiving, at a computing device, the payment account selection that is configured to direct payment of the financial transaction from one or more selected payment accounts, wherein the selected payment accounts include at least one payment account held at a financial institution other than a financial institution implementing the customer-selected payment account selection method.

17. An apparatus configured for customer-selected payment clearinghouse processing, the apparatus comprising:
a computing platform including at least one processor and a memory; and
a customer-selected payment clearinghouse application stored in the memory and executable by the at least one processor, wherein the application includes,
a payment selection routine that is configured to receive, from a customer, within a payment account selection time period, a payment account selection associated with a previously occurred financial transaction and configured to direct payment of the financial transaction from one or more selected payment accounts.

18. The apparatus of claim 17, wherein the payment selection routine is further configured to direct payment of the financial transaction from one or more default payment accounts if the payment account selection is not received from the customer within the payment account selection time.

19. The apparatus of claim 18, wherein the customer-selected payment clearinghouse application further comprises a default payment selection routine configured to receive, from the customer, one or more default payment account rules that define the one or more default payment accounts, wherein the default payment rules are based on one or more customer-assigned default payment account parameters.

20. The apparatus of claim 19, wherein the default payment selection routine is further configured to receive, from the customer, the one or more default payment rules, wherein the default payment rules are based on one or more customer-assigned default payment account parameters, wherein the default payment account parameters include one or more of financial transaction amount, financial transaction type, financial transaction time, payment account balances, or payment account limits.

21. The apparatus of claim 17, wherein the customer-selected payment clearinghouse application further comprises a payment account selection notification routine configured to provide a payment account selection notification to the customer that includes notice of a pending payment account selection based on the financial transaction and the payment account selection time period.

22. The apparatus of claim 17, wherein the customer-selected payment clearinghouse application further comprises payment selection time determining routine configured to determine the payment selection time period after the occurrence of the financial transaction based on attributes associated with the financial transaction.

23. The apparatus of claim 17, wherein the customer-selected payment clearinghouse application further comprises payment selection time determining routine configured to determine the payment selection time period after the occurrence of the financial transaction based on a current financial status of the customer.

24. The apparatus of claim 17, wherein the customer-selected payment clearinghouse application further comprises payment account recommendation routine configured to provide one or more payment account recommendations to the customer during the payment selection time period.

25. The apparatus of claim 24, wherein the payment account recommendation routine is further configured to determine the one or more payment account recommendations based on current financial status of the customer.

26. The apparatus of claim 24, wherein the payment account recommendation routine is further configured to determine the one or more payment account recommendations based on one or more customer-selected financial interests.

27. The apparatus of claim 17, wherein the customer-selected payment clearinghouse application further comprises a payment-related offer routine configured to provide one or more payment-related offers to the customer during the payment selection time period.

28. The apparatus of claim 27, wherein payment-related offer routine is further configured to determine the one or more payment-related offers based on attributes associated with the financial transaction.

29. The apparatus of claim 27, wherein payment-related offer routine is further configured to determine the one or more payment-related offers based on current financial status of the customer.

30. The apparatus of claim 17, wherein the payment account selection routine is further configured to receive, from the customer, within the payment account selection time period, the payment account selection, wherein the selected payment accounts are payment accounts held at a financial institution implementing the customer-selected payment account selection method.

31. The apparatus of claim 30 wherein the payment account selection routine is further configured to receive, from the customer, within the payment account selection time period, the payment account selection, wherein the selected payment accounts include at least one payment account held at a financial institution other than a financial institution implementing the customer-selected payment account selection method.

32. A computer program product comprising:
a non-transitory computer-readable medium comprising:
a first set of codes for causing a computer to receive notification of a financial transaction associated with a customer;
a second set of codes for causing a computer to receive, from the customer within a payment account selection time period commencing after occurrence of the financial transaction, a payment account selection configured to direct payment of the financial transaction from one or more selected payment accounts; and
a third set of codes for causing a computer to process payment of the financial transaction in accordance with the payment account selection.

33. The computer program product of claim 32, further comprising a fourth set of codes for causing a computer to process payment of the financial transaction in accordance with one or more default payment accounts if the payment account selection is not received from the customer within the payment account selection time.

34. The computer program product of claim 33, further comprising a fifth set of codes for causing a computer to receive, from the customer, one or more default payment account rules that define the default payment accounts, wherein the default payment rules are based on one or more customer-assigned default payment account parameters.

35. The computer program product of claim 34, wherein the fifth set of codes are further configured to cause the computer to receive, from the customer, the one or more default payment rules, wherein the default payment rules are based on one or more customer-assigned default payment account parameters, wherein the default payment account parameters include one or more of financial transaction amount, financial transaction type, financial transaction time, payment account balances, or payment account limits.

36. The computer program product of claim 32, further comprising a fourth set of codes configured to cause a computer to provide a payment account selection notification to the customer that includes notice of a pending payment account selection based on the financial transaction and the payment account selection time period.

37. The computer program product of claim 32, further comprising a fourth set of codes for causing a computer to determine the payment selection time after the occurrence of the financial transaction based on attributes associated with the financial transaction.

38. The computer program product of claim 32, further comprising a fourth set of codes for causing a computer to determine the payment selection time after occurrence of the financial transaction based on a current financial status of the customer.

39. The computer program product of claim 32, wherein the second set of codes is further configured to cause the computer to receive, from the customer within a predetermined payment account selection time period commencing after occurrence of the financial transaction, the payment account selection.

40. The computer program product of claim 32, further comprising a fourth set of codes configured to cause the computer to provide one or more payment account recommendations to the customer during the payment selection time period.

41. The computer program product of claim 40, wherein the fourth set of codes is further configured to cause the computer to determine the one or more payment account recommendations based on current financial status of the customer.

42. The computer program product of claim 40, wherein the fourth set of codes is further configured to cause the computer to determine the one or more payment account recommendations based on one or more customer-selected financial interests.

43. The computer program product of claim 32, further comprising a fourth set of codes for causing a computer to provide one or more payment-related offers to the customer during the payment selection time period.

44. The computer program product of claim 43, wherein the fourth set of codes is further configured to determine the payment-related offers based on attributes associated with the financial transaction.

45. The computer program product of claim 43, wherein the fourth set of codes is further configured to determine the payment-related offers based on current financial status of the customer.

46. The computer program product of claim 32, wherein the second set of codes is further configured to cause the computer to receive the payment account selection that is configured to direct payment of the financial transaction from one or more selected payment accounts, wherein the selected payment accounts are payment accounts held at a financial institution implementing the customer-selected payment account selection method.

47. The computer program product of claim 32, wherein the second set of codes is further configured to cause the computer to receive the payment account selection that is configured to direct payment of the financial transaction from one or more selected payment accounts, wherein the selected payment accounts include at least one payment account held at a financial institution other than a financial institution implementing the customer-selected payment account selection method.
